(19) United States
(12) Patent Application Publication
(10) Pub. No.: US 2008/0066132 A1
(43) Pub. Date: Mar. 13, 2008

(54) Digital television receiver and method for processing a digital television signal

(75) Inventor: Kwan Suk Kim, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/896,938

(22) Filed: Sep. 6, 2007

(30) Foreign Application Priority Data
Sep. 7, 2006 (KR) 10-2006-0086313

(51) Int. Cl. H04N 7/173

(52) U.S. Cl. 725/127

(57) ABSTRACT

A method includes receiving a digital television signal including a virtual channel table comprising a list of attributes for virtual channels carried in transport streams; demultiplexing the virtual channel table from the received digital television signal; parsing channel status information from the demultiplexed virtual channel table, the parsed channel status information defining a channel status change time and a new channel status of one of the virtual channels; and performing a channel status change of the virtual channel according to the parsed channel status information.

This application claims the benefit of Korean Patent Application No. 10-2006-0086313, filed on Sep. 07, 2006, which is hereby incorporated by reference as if fully set forth herein.

### BACKGROUND

1. Field of the Disclosure

The present disclosure relates to a digital television (DTV) receiver and a method for processing the DTV signal.

2. Discussion of the Related Art

Generally, a Program and System Information Protocol (PSIP) is a protocol for channel tuning and broadcast schedule transmission in Advanced Television Systems Committee (ATSC) as the digital broadcasting standard for terrestrial and cable digital broadcasting environments.

In addition, the PSIP is a standard protocol for the transfer of tables included within packets transferred by a multiplexed transport stream.

As the PSIP table, there is a virtual channel table (VCT) having information about a virtual channel viewed by a user with a DTV receiver, an Event Information Table (EIT) enabling an Electronics Program Guide (EPG) service, and a System Time Table (STT) for informing information about the current time.

### SUMMARY

Accordingly, the present disclosure is directed to a digital television (DTV) receiver and a method for processing DTV signal that substantially obviate one or more problems described above.

For example, the disclosure may disclose DTV receivers and methods for processing DTV signal. The DTV signal includes channel status information defining a channel status change time and a new channel status of one of the virtual channels.

Advantages, objects, and features of the invention in part may become apparent in the description which follows and in part may become apparent to those having ordinary skill in the art upon examination of the following or may be learned from practice of the invention. The objectives and other advantages of the various embodiments of the invention may be realized and attained by the structures and processes described in the written description, in the claims, and in the appended drawings.

To achieve these objects and other advantages and in accordance with the purpose of the invention, as embodied and broadly described herein, a method includes receiving a digital television signal including a virtual channel table comprising a list of attributes for virtual channels carried in transport streams; demultiplexing the virtual channel table from the received digital television signal; parsing channel status information from the demultiplexed virtual channel table, the parsed channel status information defining a channel status change time and a new channel status of one of the virtual channels; and performing a channel status change of the virtual channel according to the parsed channel status information.

In another aspect of the present invention, a DTV receiver includes a tuner tuning to a channel to receive a digital television signal; a demodulator demodulating the digital television signal; a demultiplexer demultiplexing a virtual channel table from the demodulated digital television signal; a parser parsing channel status information from the demultiplexed virtual channel table, the parsed channel status information defining a channel status change time and a new channel status of a virtual channel; and a controller performing a channel status change of the virtual channel according to the parsed channel status information.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIG. 1 is an exemplary diagram of a bit stream syntax of a terrestrial virtual channel table (TVCT) containing an active timer descriptor;

FIG. 2 is an exemplary diagram of the active timer descriptor;

FIG. 3 is an exemplary scenario using the active timer descriptor;

FIG. 4 is another exemplary scenario using the active timer descriptor;

FIG. 5 is an exemplary block diagram of a DTV receiver;

FIG. 6 is an exemplary flowchart of a method for processing a DTV signal; and

FIG. 7 is another exemplary flowchart of a method for processing a DTV signal.

### DETAILED DESCRIPTION OF THE INVENTION

Reference will now be made in detail to a digital television receiver and methods for processing a digital television signal according to the various embodiments, examples of which are illustrated in the accompanying drawings. Wherever possible, the same reference numbers will be used throughout the drawings to refer to the same or like parts for simplicity.

Hereinafter, a digital television (DTV) signal containing channel status information defining a channel status change time and a new channel status of one of the virtual channels, a DTV receiver and a method for processing the DTV signal according to the present disclosure will be described in detail with reference to the accompanying drawings.

It is assumed that the channel status information is contained in a virtual channel table (VCT) of a plurality of program and system information protocol (PSIP) tables contained in the DTV signal. At this time, the channel status information may be defined in a descriptor of the VCT. Hereinafter the descriptor containing the channel status information is called an active timer descriptor (active_timer_descriptor).

The VCT containing the active timer descriptor will be described.

The VCT contains a list of attributes for virtual channels carried in transport streams. The basic information contained in the VCT table body includes transport stream identification (ID), channel number (major and minor), short channel name, program number, access controlled flag, location field for extended text messages, and service type. Additional information may be carried by descriptors that may be placed in the descriptor loop after the basic information.

The VCT may be segmented into as many as 256 sections. One section may contain information for several virtual channels, but the information for one virtual channel should not be segmented and put into two or more sections. Thus for each section, the first field after protocol_version should be num_channels_in_section. Each virtual channel is associated with a program_number. Every program element associated with that program_number should be considered to be a part of that virtual channel.

The VCT includes a terrestrial virtual channel table (TVCT) for terrestrial broadcasting and a cable virtual channel table (CVCT) for cable broadcasting. Hereinafter, for convenience of description, for example, the TVCT will be described.

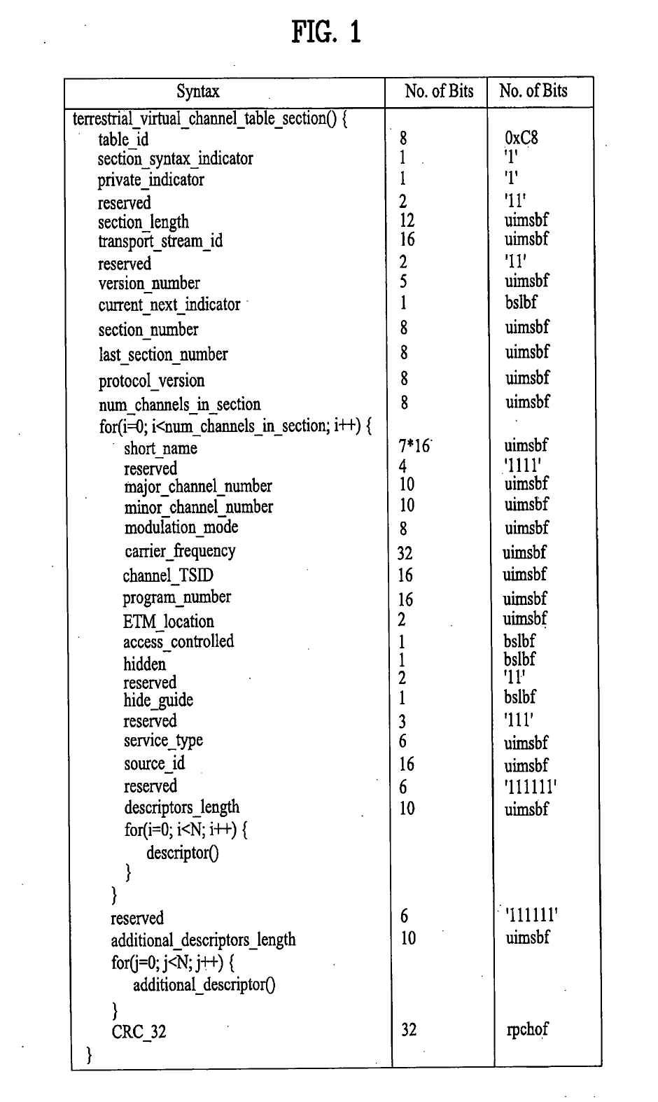

FIG. 1 is an exemplary diagram of a bit stream syntax of a terrestrial virtual channel table (TVCT) containing an active timer descriptor.

In the structure of the TVCT, tables having specific purposes are defined in the PSIP and have section structures similar to those of the tables defined in a program specific information (PSI) of the moving picture experts group (MPEG). That is, each table has a section for transfer and may have one or a plurality of sections according to the type thereof. At this time, the section is divided into a header containing the basic information of the section and table necessary for selectively receiving the section, a message body containing the actual data of the table, and a trailer containing information for error correction.

The VCT section shown in FIG. 1 has the above-described structure, the header contains a table_id” field to a “protocol_version” field, the message body contains a “system_time” field to a “descriptor” field, and the trailer contains “CRC_{—}32” field, which will now be described in this order.

First, the header will be described. A “table_id” field is an 8-bit field, which should be set to ‘0xC8’, identifying this table as the TVCT. A “section_syntax_indicator” field is a 1-bit field that should be set to ‘1’ for the TVCT section.

A “private_indicator” field is a 1-bit field that should be set to ‘1’. A “section_length” field is a 12-bit field, the first two bits of which should be ‘00’. It specifies the number of bytes of the section, starting immediately following the section_length field, and including a cyclic redundancy check (CRC). The value in this field should not exceed ‘1021’. A “transport_stream_id” field is a 16-bit MPEG-2 transport stream ID, as it appears in the program association table (PAT) identified by a packet identifier (PID) value of zero for this multiplex. The transport_stream_id distinguishes this TVCT from others that may be broadcast in different PTCs.

A “version_number” field is a 5-bit field that is the version number of the VCT. For the current VCT (current_next_indicator=‘1’), the version number should be incremented by 1 whenever the definition of the current VCT changes. Upon reaching the value ‘31’, it wraps around to ‘0’. For the next VCT (current_next_indicator=‘0’), the version number should be one unit more than that of the current VCT (also in modulo 32 arithmetic). In any case, the value of the version_number should be identical to that of the corresponding entries in the master guide table (MGT). A “current_next_indicator” field is a 1-bit indicator that when set to ‘1’ indicates that the VCT sent is currently applicable. When the bit is set to ‘0’, it indicates that the table sent is not yet applicable and should be the next table to become valid.

A “section_number” field is an 8-bit field gives the number of this section. The section_number of the first section in the TVCT should be ‘0x00’. It should be incremented by one with each additional section in the TVCT. A “last_section_number” field is an 8-bit field that specifies the number of the last section (that is, the section with the highest section_number) of the complete TVCT. A “protocol_version” field is an 8-bit unsigned integer field whose function is to allow, in the future, this table type to carry parameters that may be structured differently than those defined in the current protocol.

Next, the message body will be described. A “num_channels_in_section” field is an 8-bit field that specifies the number of virtual channels in the VCT section. A “short_name” field is the name of the virtual channel, represented as a sequence of one to seven 16-bit code values interpreted in accordance with the UTF-16 representation of unicode character data.

A “major_channel_number” field is a 10-bit number that represents a “major” channel number associated with the virtual channel being defined in this iteration of the “for” loop. Each virtual channel should be associated with a major and a minor channel number. The major_channel_number, along with the minor_channel_number, act as the user's reference number for the virtual channel. The major_channel_number should be between ‘1’ and ‘99’. The value of major_channel_number should be set such that in no case is a major_channel_number/minor_channel_number pair duplicated within the TVCT. A “minor_channel_number” field is a 10-bit number in the range ‘0’ to ‘999’ that represents the “minor” or “sub”-channel number. This field, together with major_channel_number, performs as a two-part channel number, where minor_channel_number represents the second or right-hand part of the number. When the service_type is analog television, minor_channel_number should be set to ‘0’. Services whose service_type is either ATSC_digital_television or ATSC_audio_only should use minor numbers between ‘1’ and ‘99’. The value of minor_channel_number should be set such that in no case is a major_channel_number/minor_channel_number pair duplicated within the TVCT. For other types of services, such as data broadcasting, valid minor virtual channel numbers are between ‘1’ and ‘999’.

A “modulation_mode” field is an 8-bit unsigned integer number that indicates the modulation mode for the transmitted carrier associated with this virtual channel. For digital signals, the standard values for modulation mode (values below ‘0x80’) indicate transport framing structure, channel coding, interleaving, channel modulation, forward error correction, symbol rate, and other transmission-related parameters, by means of a reference to an appropriate standard. The modulation_mode field should be disregarded for inactive channels. A “carrier_frequency” field is the recommended value for these ‘32’ bits of zero. Use of this field to identify carrier frequency is allowed, but is deprecated. A “channel_TSID” field is a 16-bit unsigned integer field in the range ‘0x0000’ to ‘0xFFFF’ that represents the MPEG-2 transport stream (TS) ID associated with the TS carrying the MPEG-2 program referenced by this virtual channel. For inactive channels, channel_TSID should represent the ID of the Transport Stream that will carry the service when it becomes active. The receiver is expected to use the channel_TSID to verify that any received TS are actually the desired multiplex. For analog channels (service_type 0x01), channel_TSID should indicate the value of the analog TSID included in a vertical blanking interval (VBI) of the national television system committee (NTSC) signal.

A “program_number” field is a 16-bit unsigned integer number that associates the virtual channel being defined here with the MPEG-2 program association and TS program map tables. For virtual channels representing analog services, a value of ‘0xFFFF’ should be specified for program_number. For inactive channels (those not currently present in the TS), program_number should be set to zero. This number should not be interpreted as pointing to a program map table (PMT) entry.

An “ETM_location” field is a 2-bit field that specifies the existence and the location of an extended text message (ETM). An “access_controlled” field is a 1-bit Boolean flag that indicates, when set, that the events associated with this virtual channel may be access controlled. When the flag is set to ‘0’, event access is not restricted.

A “hidden” field is a 1-bit Boolean flag that indicates, when set, that the virtual channel is not accessed by the user by direct entry of the virtual channel number. Hidden virtual channels are skipped when the user is channel surfing, and appear as if undefined, if accessed by direct channel entry. Typical applications for hidden channels are test signals and near video on demand (NVOD) services. Whether a hidden channel and its events may appear in electronics program guide (EPG) displays depends on the state of the hide_guide bit. A “hide_guide” field is a Boolean flag that indicates, when set to ‘0’ for a hidden channel, that the virtual channel and its events may appear in EPG displays. This bit should be ignored for channels that do not have a hidden bit set, so that non-hidden channels and their events may always be included in EPG displays regardless of the state of the hide_guide bit. Typical applications for hidden channels with the hide_guide bit set to ‘1’ are test signals and services accessible through application-level pointers.

A “service_type” field is a 6-bit enumerated type field that should identify the type of service carried on this virtual channel. A “source_id” field is a 16-bit unsigned integer number that identifies the programming source associated with the virtual channel. In this context, a source is one specific source of video, text, data, or audio programming. Source ID value zero is reserved. Source ID values in the range ‘0x0001’ to 0x0FFF should be unique within the TS that carries the VCT, while values ‘0x1000’ to ‘0xFFFF’ should be unique at the regional level.

A “descriptors_length” field is the total length (in bytes) of the descriptors for this virtual channel that follows. A “descriptors ( )” field may include one or more descriptors, as appropriate. At this time, the descriptor contains the active timer descriptor. The detailed description of the active timer descriptor will be made later. An “additional_descriptors_length” field is the total length (in bytes) of the VCT descriptor list that follows.

Finally, the trailer will be described. A “CRC_{—}32” field is a 32-bit field that contains the CRC value that ensures a zero output from the registers in the decoder after processing the entire TVCT section.

Up to now, the structure of the TVCT section was described. Hereinafter, the active timer descriptor (active_timer_descriptor) will be described.

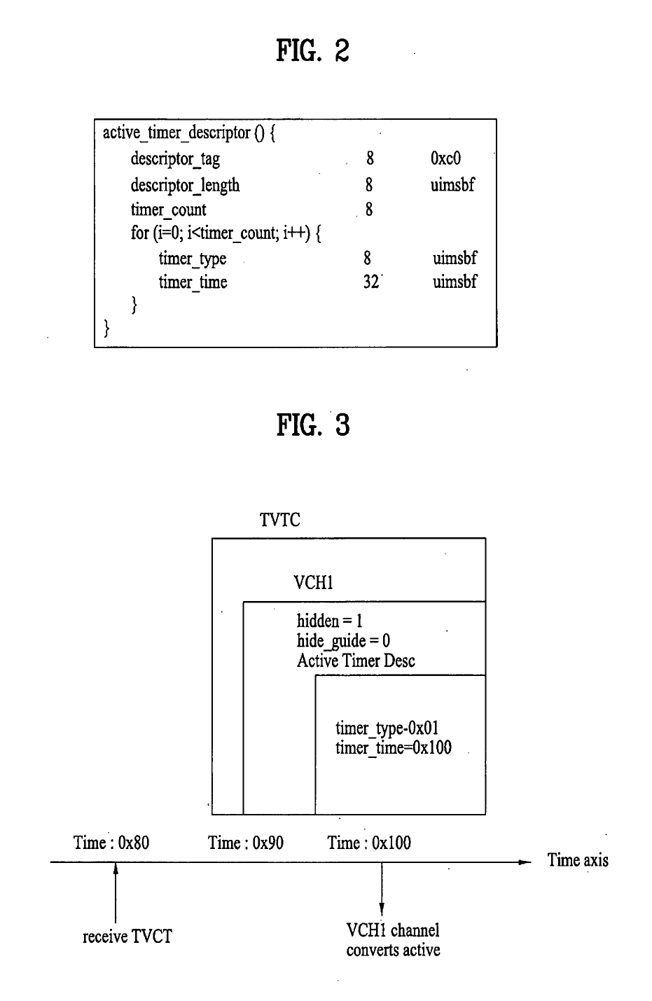

FIG. 2 is an exemplary diagram of the active timer descriptor.

The active timer descriptor contains channel status information defining a channel status change time and a new channel status of one of the virtual channels. At this time, the new channel status in the channel status information is, for example, contained in a “timer_type” field. Also, the channel status change time in the channel status information is, for example, contained in a “timer_time” field.

Referring to FIG. 2, the active timer descriptor may contain a “descriptor_tag” field which is the basic information of a descriptor, a “descriptor_length” field, a “timer_count” field, and the loop structure of the “timer_count” field.

The “timer_count” field contains information (hereinafter, referred to as a timer) on at least one channel state.

The “timer_type” field defines the changed channel status of the channel to which the timer is applied. At this time, the changed channel status may be defined in association with the receiver's behavior according to the attributes of the “hidden” field and the “hide_guide” field. For example, it is indicated that the channel is changed to an active channel if the value of the “timer_type” field is ‘0x01’, is changed to an inactive channel if the value of the “timer_type” field is ‘0x02’, and is changed to a special access only channel if the value of the “timer_type” field is ‘0x03’. For future use, ‘0x04’ to ‘0xFF’ are assigned and used as the values of the “timer_type” field. The channel state depends on the attributes of the “hidden” field and the “hide_guide” field.

A channel that is currently active should be available by surfing (sequential channel display via repeated activation of a single control by the receiver user) as well as through the receiver's program guide user interface. The broadcaster indicates this by setting hidden to ‘0’. When hidden is ‘0’ the value of hide_guide is meaningless and should be ignored.

When a channel is currently inactive, the receiver should skip over that channel while the user is surfing, but future program listings should be viewable in the program guide. The broadcaster should assign ‘1’ to hidden and ‘0’ to hide_guide for these channels in the current VCT.

When a channel is currently special access only, the receiver should skip over that channel while the user is surfing, but future program listings should be viewable in the hide guide only. The broadcaster should assign ‘1’ to hidden and ‘1’ to hide_guide for these channels in the current VCT.

The “timer_time” field contains a start time for applying the timer, that is, time information for applying the changed channel state according to the “timer_type” field. The time information may use a global positioning system (GPS) time and the “timer_time” field has 32 bits.

Accordingly, a DTV receiver parses the “timer_count” field and applies a changed channel state defined by the “timer_type” field to the timer at a time point defined by the “timer_time” field. At this time, if the number of timers defined by the “timer_count” field is plural, the channel state can be defined and thus the receiver can the changed channel state even when the channel state is changed to a specific state S1 at a specific timer point T1 and is then changed from the specific state S1 to a specific state S2 at another specific time point T2 after the specific time point T1. That is, the DTV receiver can process the channel state which is continuously changed and most efficiently provide the channel information to a program guide at desired time points according to the channel state.

Therefore, the DTV receiver can parse the active timer descriptor to know when the channel state is changed, and apply the channel state in real time to provide more accurate guide information to a user. This includes a case where the channel is changed from an inactive or special access only to an active at a specific time point or a case where the channel is changed from an active to an inactive or special access only at a specific time point.

Hereinafter, a scenario of changing and applying the channel state using the active timer descriptor will be described. FIG. 3 is an exemplary scenario using the active timer descriptor.

In a central time axis shown in FIG. 3, a time passes from the left side to the right side. For example, the DTV receiver receives the TVCT section and parses at a time point “0x80’. The DTV receiver can know that a virtual channel number ‘1’ is in an inactive from the parsed result that the value of the “hidden” field in the TVCT section is set to ‘1’ and the value of the “hide_guide” field is set to ‘0’. That is, the virtual channel number 1 is in the inactive at a time point ‘0x90’. Accordingly, the receiver skips over the virtual channel number 1 which is in the inactive at the time point ‘0x90’, for example, when the user surfs the channels.

However, when the active timer descriptor is parsed and used, the DTV receiver can know whether the channel state is changed, the changed state, and the changed time. That is, the DTV receiver can know that the virtual channel number 1 is in the inactive at current (the time point ‘0x90’) by parsing the TVCT section and can know that the virtual channel number 1 is changed after the time point ‘0x90’ by parsing the active timer descriptor, thereby appropriately coping with the change of the channel state.

The DTV receiver can know whether the channel state is changed and the changed state from the “timer_type” field in the active timer descriptor. That is, the DTV receiver can know whether the channel state is changed and the changed channel state by comparing the channel state defined by the TVCT section with the channel state defined by the “timer_type” field.

The DTV receiver can know when the state defined by the “timer_type” field is applied, from the time information contained in the “timer_time” field of the active timer descriptor.

For example, the DTV receiver can know that the virtual channel number 1 is in the inactive at the time point ‘0x90’ but is changed to the active indicated by ‘0x01’ at a time point ‘0x100’, from the value ‘0x01’ of the “timer_type” field and the value ‘0x100’ of the “timer_time” field in the active timer descriptor.

Accordingly, the DTV receiver sets the timer to change the channel state of the virtual channel number 1 to the active at the time point ‘0x100’ such that adequate channel information is provided when the user surfs or requests the program guide. FIG. 3 shows the scenario when the channel is changed from the inactive to the active and a single timer is used.

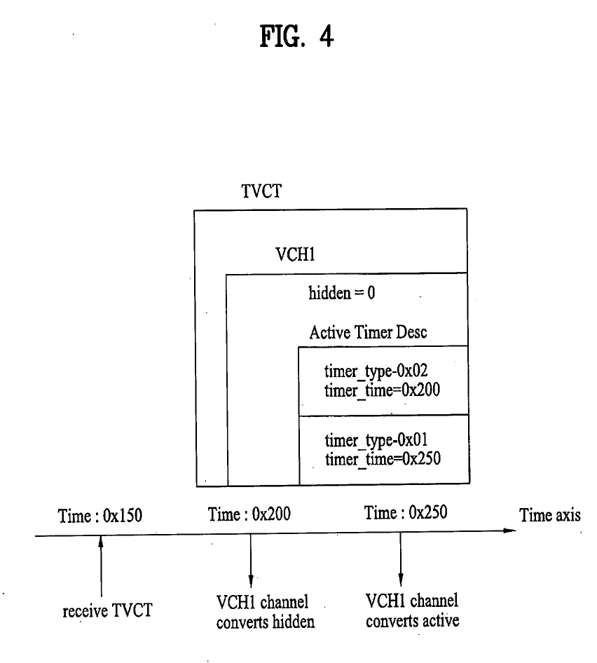

As another example, a case where the channel is changed from the special access only to the inactive through the active state will be described. FIG. 4 is another exemplary scenario using the active timer descriptor. Accordingly, in FIG. 4, two pieces of timer information are contained in the “timer_count” field.

In a central time axis shown in FIG. 4, a time passes from the left side to the right side, similar to FIG. 3. For example, the DTV receiver receives the TVCT section at a time point ‘0x150’ and parses the active timer descriptor in the TVCT section. It can be seen that the virtual channel number 1 is in the special access only, from the parsed result that the value of “hidden” field of the TVCT section is set to ‘1’ and the value of the “hide_guide” field is set to ‘1’ at present (time point ‘0x150’). Accordingly, the receiver skips over the virtual channel number 1 which is in the special access only at the time point ‘0x150’, for example, when the user surfs the channels.

However, when the active timer descriptor is parsed and used, the DTV receiver can know whether the channel state is changed, the changed state, and the changed time. That is, the DTV receiver can know that the virtual channel number 1 is in the special access only at present (time point ‘0x150’) by parsing the TVCT section. Then, the DTV receiver can know that the channel state is changed using the information of the two timers by parsing the active timer descriptor. That is, the DTV receiver can cope with the change of the channel state of the virtual channel number 1 using the information of a timer 1 at a time point ‘0x200’ and the information of a timer 2 at a timer point ‘0x250’.

The DTV receiver can know that the virtual channel number 1 is changed to the inactive by the timer 1 of which the value of the “timer_time” field is set to ‘0x200’ and the value of the “timer_type” field is set to ‘0x02’ and know that the virtual channel number 1 is changed to the active by the timer 2 of which the value of the “timer_time” field is set to ‘0x250’ and the value of the “timer_type” field is set to ‘0x01’. That is, the receiver can know that the virtual channel number 1 is in the special access only at the time point ‘0x150’, is changed to the inactive at the time point ‘0x200’, and is changed to the active at the time point ‘0x250’, by setting and using the two timers. Accordingly, the DTV receiver can provide information according to the request of the user in correspondence with the change of the channel state at specific time points.

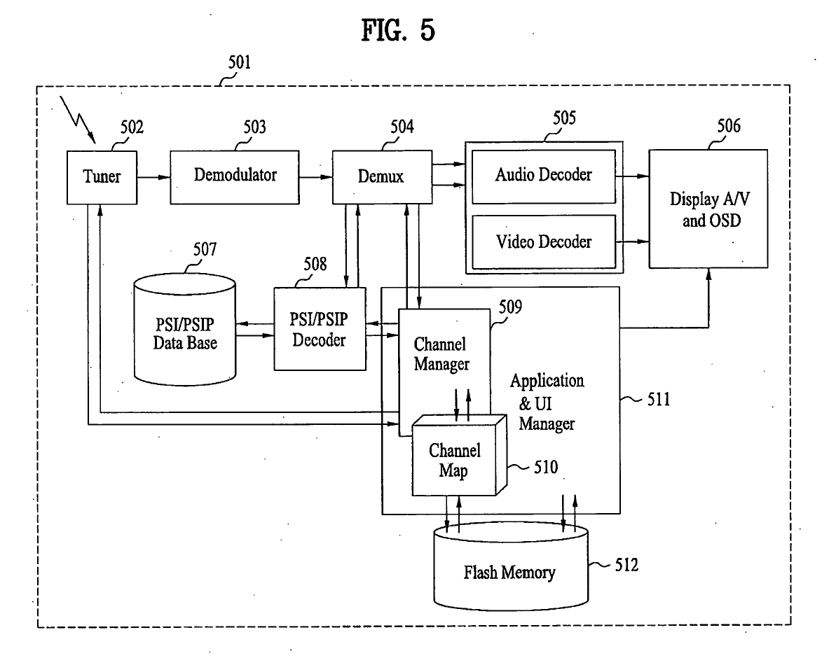

Hereinafter, a digital television (DTV) receiver for processing a DTV signal containing channel status information will be described. FIG. 5 is an exemplary block diagram of a DTV receiver.

The DTV receiver 501 includes a tuner 502, a demodulator 503, a demultiplexer 504, an audio/video (A/V) decoder 505, a display A/V and on screen display (OSD) 506, a program specific information/program and system information protocol (PSI/PSIP) database 507, a PSI/PSIP decoder 508, a channel manager 509, a channel map 510, and an application and user interface (UI) manager 511.

The tuner 502 tunes a digital television signal containing a plurality of tables having specific purposes. Among the plurality of tables, a VCT contains, for example, an active timer descriptor containing channel status information. The tuner 502 is controlled by the channel manager 509 such that the result of the received DTV signal is recorded in the channel manager 509.

The demodulator 503 demodulates the DTV signal tuned by the tuner 502 into a vestigial side band/enhanced vestigial side band (VSB/EVSB) signal.

The demultiplexer 504 demultiplexes an audio, video, and the plurality of tables from transport packets demodulated by the demodulator 503. The demultiplexing of the tables is controlled by the PSI/PSIP decoder 508 and the demultiplexing of the audio and video is controlled by the channel manager 509. When the PSI/PSIP decoder 508 sets a packet identifier (PID) for a desired table as a condition, the demultiplexer 504 filters a specific table section for satisfying the condition from the received transport packets and transmits the section to the PSI/PSIP decoder 508. When the channel manager 509 sets an A/V PID of a corresponding virtual channel as a condition, the demultiplexer 504 demultiplexes an A/V elementary stream and transmits the demultiplexed A/V elementary steam to the A/V decoder 505.

The A/V decoder 505 decodes the demultiplexed A/V elementary stream (ES) and outputs the decoded data to the display A/V and OSD 506.

The PSI/PSIP decoder 508 parses the table section filtered by the demultiplexer 504 and records actual section data in the PSI/PSIP database 507.

The channel manager 509 may request the reception of a channel-related information table by referring to the channel map 510 and receive the result. At this time, the PSI/PSIP decoder 508 controls the demultiplexing of the channel-related information table and transmits a list of A/V PIDs to the channel manager 509. The channel manager 509 may directly control the demultiplexer 504 using the received A/V PID to control the A/V decoder 505.

The application and UI manager 511 may control a graphical user interface (GUI) for displaying the state of the receiver with an OSD.

The display A/V and OSD 506 displays information requested by the user according to the active timer descriptor stored in the PSI/PSIP database 507 under the control of the application and UI manager 511.

The PSI/PSIP decoder 508 sets the PID of the VCT section containing the channel status information as the condition to control the filtering of the demultiplexer 504 and parses the VCT section which is filtered by the demultiplexer 504 under the control of the PSI/PSIP decoder 508. At this time, the active timer descriptor in the VCT is also parsed. Accordingly, it is possible to obtain whether the channel state is changed, the changed channel state, and the changed time using the information of the parsed VCT and active timer descriptor.

The PSI/PSIP decoder 508 controls the channel manager 509 using the active timer descriptor information with respect to the corresponding channel. That is, the PSI/PSIP decoder 508 controls the channel manager 509 to set the timer using the information of the parsed active timer descriptor, determines whether a time reaches a time point when the corresponding timer operates or the channel state is changed after setting the timer, and controls the channel manger 509 such that the channel state is changed at the time point when the channel state is determined to be changed.

The channel manager 509 may confirm and change the channel state by referring to the channel map 510 when a control signal is received from the PSI/PSIP decoder 508 using the VCT information and the active timer descriptor information.

The demultiplexer 504 can check only the header of the table transmitted from the broadcasting station using the PID, the table_id, the version_number, the section_number, and the table_id_extention. That is, the demultiplexer 504 can parse only the header and filter a specific table except for a duplicated or new table.

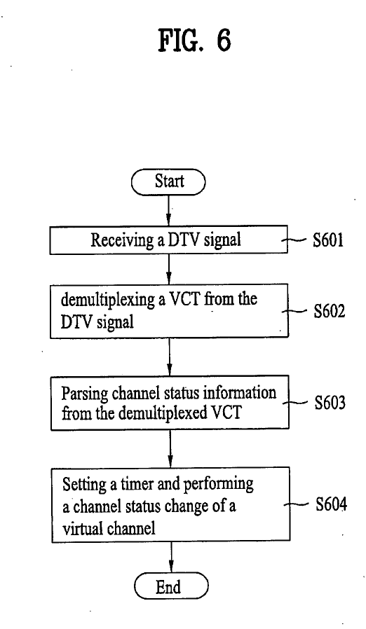

Next, a method for processing a digital television (DTV) signal at the DTV receiver will be described. FIG. 6 is an exemplary flowchart of a method for processing a DTV signal.

First, the DTV receiver receives and demodulates a DTV signal (S601). At this time, the DTV signal, for example, contains a virtual channel table included a list of attributes for virtual channels carried in transport streams.

The DTV receiver demultiplexes the VCT from the demodulated DTV signal (S602).

And, the DTV receiver parses an active timer descriptor from the demultiplexed VCT. At this time, channel status information in the active timer descriptor defines a channel status change time and a new channel status of one of the virtual channels (S603).

Finally, the DTV receiver sets a timer and performs a channel status change of the virtual channel according to the parsed channel status information (S604).

Accordingly, the receiver can provide channel information according to the changed channel state when the user surfs or requests program guide information.

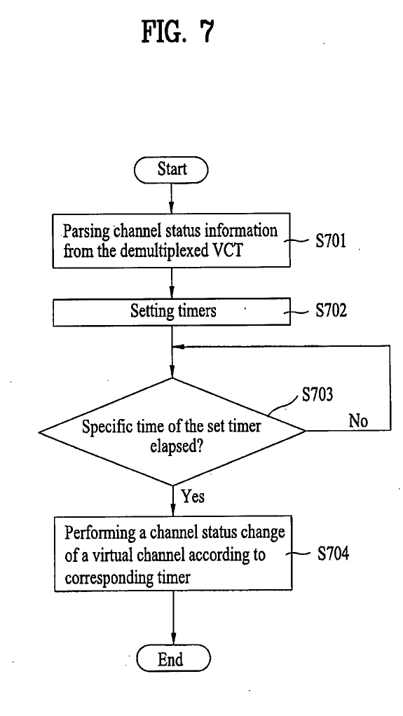

FIG. 7 is another exemplary flowchart of a method for processing a DTV signal.

In FIG. 7, the number of timers used for a specific channel is plural. Accordingly, the state of the specific channel is changed by the timers, similar to the method illustrated in FIG. 6. Accordingly, the DTV receiver receives and demodulates a DTV signal containing contains a virtual channel table included a list of attributes for virtual channels carried in transport streams. The DTV receiver demultiplexes the VCT from the demodulated DTV signal.

And, the DTV receiver parses an active timer descriptor from the demultiplexed VCT. At this time, the number of timers used for a specific channel is plural. Each timer defines a channel status change time and a new channel status of corresponding virtual channel (S701).

The DTV receiver sets each timer (S702).

It is determined whether a specific time point, which is set in a first timer, elapses (S703).

If it is determined that the specific time of the first timer does not elapses, a standby state is maintained. In contrast, if it is determined that the specific time point of the first timer elapses, the channel state is changed (S704).

The method returns to the step S703 and the process after the step S703 is performed with respect to the other timer. The process after the step S703 is repeatedly performed with respect to all the timers. Accordingly, the changed channel state is set and applied in real time although the channel state is continuously changed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing a digital television signal in a digital television receiver, the method comprising:
receiving a digital television signal including a virtual channel table comprising a list of attributes for virtual channels carried in transport streams;
demultiplexing the virtual channel table from the received digital television signal;
parsing channel status information from the demultiplexed virtual channel table, the parsed channel status information defining a channel status change time and a new channel status of one of the virtual channels; and
performing a channel status change of the virtual channel according to the parsed channel status information.

2. The method of claim 1, wherein the channel status change time the channel status information are in global positioning system (GPS) second.

3. The method of claim 1, wherein the new channel status is one of active, inactive and special access only in accordance with attributes of hidden field and hide_guide field from the demultiplexed virtual channel table.

4. The method of claim 3, wherein the active is available corresponding channel by user's surfing as well as through program guide user interface.

5. The method of claim 3, wherein the inactive is skipped over corresponding channel while a user is surfing and viewable future program listings in program guide.

6. The method of claim 3, wherein the special access only is viewable future program listings in hide guide.

7. The method of claim 1, further comprising setting at least one of timer according to the channel status change time from the parsed channel status information.

8. The method of claim 7, further comprising determining a specific time point of the set timer elapsed.

9. A digital television receiver comprising:
a tuner tuning to a channel to receive a digital television signal;
a demodulator demodulating the digital television signal;
a demultiplexer demultiplexing a virtual channel table from the demodulated digital television signal;
a parser parsing channel status information from the demultiplexed virtual channel table, the parsed channel status information defining a channel status change time and a new channel status of a virtual channel; and
a controller performing a channel status change of the virtual channel according to the parsed channel status information.

10. The method of claim 9, wherein the channel status change time the channel status information are in global positioning system (GPS) second.

11. The method of claim 9, wherein the new channel status is one of active, inactive and special access only in accordance with attributes of hidden field and hide_guide field from the demultiplexed virtual channel table.

12. The method of claim 11, wherein the controller controls to perform available corresponding channel by user's surfing as well as through a program guide user interface if the new channel status is changed active.

13. The method of claim 11, wherein the controller controls to perform skip over corresponding channel while a user is surfing and be viewable future program listings in program guide if the new channel status is changed inactive.

14. The method of claim 11, wherein the controller controls to perform viewable future program listings in hide guide if the new channel status is changed special access only.

15. The method of claim 9, wherein the controller controls to set at least one of timer according to the channel status change time from the parsed channel status information.

16. The method of claim 9, wherein the controller controls to determine a specific time point of the set timer elapsed.
